(19) United States
(12) Patent Application Publication
(10) Pub. No.: US 2011/0280251 A1
(43) Pub. Date: Nov. 17, 2011

(54) APPARATUS HAVING A FIXTURE WITH AN INTEGRATED GATEWAY AND METHODS THEREOF

(75) Inventors: Gary Fails, Tappan, NY (US); Lauren E. Dunn, New York, NY (US); Paul Kleissler, Englewood, NJ (US)

(73) Assignee: CITY THEATRICAL INC., Carlstadt, NJ (US)

(21) Appl. No.: 13/153,703

(22) Filed: Jun. 6, 2011

Related U.S. Application Data
(63) Continuation-in-part of application No. 12/618,712, filed on Nov. 14, 2009.
Application No. 12/618,712 is a continuation-in-part of application No. 11/109,012, filed on Apr. 18, 2005.
(60) Provisional application No. 60/582,695, filed on Jun. 24, 2004.
(60) Provisional application No. 61/352,552, filed on Jun. 8, 2010.

(51) Int. Cl. H04L 12/56

(52) U.S. Cl. 370/401

(57) ABSTRACT

Apparatus and method for a fixture with integrated gateway capabilities is provided. In one embodiment, a fixture with integrated gateway may include an output, an input for receiving data formatted in an industry-standard communication protocol, a logic unit configured to selectively distribute received data, and an integrated gateway configured to receive the data formatted in the industry-standard communication protocol and convert the data to a second data format. A user interface, in communication with the integrated gateway, for receiving input commands from a user, may be provided.

### CROSS-REFERENCE TO RELATED APPLICATIONS

This application is a Continuation-In-Part of U.S. patent application Ser. No. 12/618,712, filed Nov. 14, 2009, which in turn is a Continuation-In-Part of U.S. patent application Ser. No. 11/109,012, filed Apr. 18, 2005, which claims the benefit of U.S. Provisional Application Ser. No. 60/582,695, filed Jun. 24, 2004, the content of all of which are hereby incorporated by reference in their entirety. This application also claims the benefit of U.S. Provisional Application Ser. No. 61/352,552, filed Jun. 8, 2010, the content of which is also hereby incorporated by reference in its entirety.

### BACKGROUND

1. Field of the Invention

Embodiments of the present invention generally relate to a fixture with integrated gateway and methods of utilizing the same. More specifically, embodiments of the present invention relate to a fixture with integrated gateway and methods for controlling entertainment and architectural fixtures utilizing the same.

Embodiments of the present disclosure also generally relate to a power supply apparatus and method of utilizing the same. More specifically, embodiments of the present disclosure relate to a power supply apparatus and methods for selectively controlling entertainment and architectural fixtures utilizing the same.

2. Description of Related Art

Entertainment and architectural lighting devices are often elaborate and include a vast array of fixtures that produce numerous effects. Traditionally, the set up of these systems has been a manually intensive and time-consuming process involving the manual configuration of settings on each fixture. In order to reduce the time and complexity of setting up these systems, computerized power supply systems have been designed. Furthermore, control data for controlling the attributes of each fixture is transmitted in numerous data formats in accordance with different industry-standard communication protocols or non-industry standard formats. Existing fixtures are configured to receive specific types of data formats.

Generally, in current power and data supply systems, an initial manual configuration or assignment of a communication protocol address is required in order to operate a fixture with an industry-standard controller. Effectively, the serial number of the fixture is assigned a standard address (e.g., a DMX address) utilizing local controls or a hand-held device, and the address is associated with that fixture until a user goes through a labor intensive process of manually configuring or re-assigning a new address to the fixture(s) in a system.

Other current designs utilize a fixed slot size per output port, and all output ports are configured the same. Thus, these current designs can only support fixtures of the same slot count. Since each port has the same slot footprint, and there is only one DMX address for the base unit, each port is then assigned an address as the base address plus slot size of the previous port, effectively locking the fixture address and drastically reducing any flexibility.

Thus, there is a need for a power supply apparatus for providing power and data to a plurality of loads, capable of configuring each port to have a unique address and slot size, thus providing unique control of every load in communication therewith.

Recent advancements in industry-standard communication protocol development have resulted in increased data distribution via a single wire or wireless medium. In order to take advantage of the recent advancements in protocol development, fixtures must be able to receive data formats in accordance with the new protocols. Many earlier, or non-industry standard, fixtures, however, are configured to receive data in earlier, or non-industry standard, formats and are unable to receive data formatted in accordance with the new protocols. As a result, in order to control the attributes of earlier, or non-industry standard, fixtures with current protocol formats in current control systems, gateway node units must be employed to convert the data formatted in accordance with the new protocols to data formats capable of reception by earlier, or non-industry standard, fixtures.

Thus, there is a need for a fixture with integrated gateway and methods for controlling entertainment and architectural fixtures utilizing the same.

### SUMMARY

Embodiments of the present invention generally relate to a power supply apparatus and method of utilizing the same. In one embodiment of the present invention, a power supply comprises a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output, and a converter configured to receive the data formatted in the industry-standard communication protocol and convert the data to a protocol compatible with a load.

In another embodiment of the present invention, a power supply system comprises a controller for transmitting control data to a power supply, the control data formatted in an industry-standard communication protocol, a plurality of loads, and a power supply comprising a plurality of outputs, each output configured for an assignable start address and a variable number of slots, an input for receiving control data from the controller, a logic unit configured to assign the start address and the number of slots for each output, the logic unit further configured to selectively distribute received control data to each output, a power unit configured to provide power through each output, and a converter configured to receive the control data formatted in the industry-standard communication protocol and convert the control data to a protocol compatible with at least one of the plurality of loads.

In yet another embodiment of the present invention, a method for operating a plurality of controllable loads comprises providing a power supply, the power supply comprising a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output, and a converter configured to receive the data formatted in the industry-standard communication protocol and convert the data to a protocol compatible with a load; providing a plurality of loads; establishing a first number of slots for a first output of the plurality of outputs, and associating a number of loads therewith; establishing a second number of slots for a second output of the plurality of outputs, and associating a number of loads therewith; assigning a first start address with the first output; and assigning a second start address with the second output.

Embodiments of the present invention generally relate to a fixture with integrated gateway capabilities and methods of utilizing the same. In one embodiment of the present invention, a fixture with integrated gateway comprises an output, an input for receiving data formatted in an industry-standard communication protocol, a logic unit configured to selectively distribute received data, and an integrated gateway, configured to receive the data formatted in the industry-standard communication protocol and convert the data to a second data format.

In another embodiment of the present invention, fixture control system comprises a controller for transmitting control data to fixtures, the control data formatted in an industry-standard communication protocol, an Ethernet interface configured to receive control data formatted in an industry-standard communication protocol and route the control data to at least one fixture with integrated gateway, at least one fixture with integrated gateway comprising an output, an input for receiving data formatted in an industry-standard communication protocol, a logic unit configured to selectively distribute received data, and an integrated gateway configured to receive the data formatted in the industry-standard communication protocol and convert the data to a second data format.

In yet another embodiment of the present invention, a method for operating a plurality of controllable fixtures comprising a controller for transmitting control data to fixture, the control data formatted in an industry-standard communication protocol; an Ethernet interface configured to receive control data formatted in an industry-standard communication protocol and route the control data to at least one fixture with integrated gateway, at least one fixture with integrated gateway comprising an output, an input for receiving data formatted in an industry-standard communication protocol, a logic unit configured to selectively distribute received data, and an integrated gateway configured to receive the data formatted in the industry-standard communication protocol and convert the data to a second data format; transmitting control data formatted in an industry-standard communication protocol from the controller to the Ethernet interface, routing the control data to the at least one fixture with integrated gateway, converting the control data to a second data format and transmitting the converted control data to an additional fixture capable of receiving the converted control data.

### BRIEF DESCRIPTION OF THE DRAWINGS

So the manner in which the above-recited features of the present invention can be understood in detail, a more detailed description of embodiments of the present invention is described below with references to the Figures illustrated in the appended drawings. The Figures in the appended drawings, like the detailed description, illustrate only examples of embodiments. As such, the Figures and the detailed description are not to be considered limiting, and other equally effective examples are possible and likely, wherein:

FIG. 1 depicts a schematic diagram of a power supply in accordance with one embodiment of the present invention;

FIG. 2 depicts a schematic diagram of a power supply system in accordance with one embodiment of the present invention;

FIG. 3 depicts a flowchart illustrating a method of processing input data within a power supply in accordance with one embodiment of the present invention;

FIG. 4 depicts a flowchart illustrating a method of operating a power supply in accordance with one embodiment of the present invention;

FIG. 5 depicts a system level block diagram of a fixture and control system;

FIG. 6 depicts a system block diagram of a fixture with integrated gateway in accordance with an embodiment of the present invention;

FIG. 7 depicts a system level block diagram of a side by side comparison of a currently available fixture device with a traditional gateway and a device in accordance with embodiments of the present invention;

FIG. 8 depicts a system level block diagram of a fixture control system in accordance with an embodiment of the present invention;

FIG. 9 depicts a flowchart of data processing within a device in accordance with an embodiment of the present invention; and

FIG. 10 depicts a flowchart illustrating a method of operating a control system in accordance with an embodiment of the present invention.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including but not limited to. To facilitate understanding, like reference numerals have been used, where possible, to designate like elements common to the Figures.

### DETAILED DESCRIPTION

Embodiments of the present disclosure generally relate to a power supply apparatus and method of utilizing the same. More specifically, embodiments of the present disclosure relate to a power supply apparatus and methods for selectively controlling entertainment and architectural fixtures utilizing the same.

Embodiments of the present invention generally relate to a fixture with integrated gateway and methods of utilizing the same. More specifically, embodiments of the present invention relate to a fixture with integrated gateway and methods for controlling entertainment and architectural fixtures utilizing the same.

As used herein, the term “load,” and derivative forms thereof, may refer to any entertainment and/or architectural fixture, including entertainment and/or architectural lighting and effect devices, for example, stationary and moving luminaries, dimmers, stepper motors, fog/smoke generators, and the like.

As used herein, the term “fixture” or “device” and derivative forms thereof, may refer to any entertainment and/or architectural fixture, including entertainment and/or architectural lighting and effect devices, for example, stationary and moving luminaries, dimmers, stepper motors, fog/smoke generators, transmitters, receivers, transceivers, and the like, capable of operating in accordance with the disclosure provided herein. In certain embodiments, however, the terms may refer to a traditional fixture, and the intended use of such term will be apparent to one of ordinary skill in the art upon reading this disclosure.

As used herein, the term “industry-standard communication protocol,” and derivative forms thereof, may refer to any conventional communication protocol, including, for example, DMX512, Remote Device Management (RDM), Advanced Control Network (ACN), Streaming ACN, RDMnet, ArtNet, Wireless DMX, Bluetooth, WiMax, Wi-Fi, Ultra Wideband (UWB), Wireless Application Protocol (WAP), Universal Mobile Telecommunications Power supply system (UMTS), Evolution-Data Optimized (EV-DO), High Speed Packet Access (HSPA), Code Division Multiple Access 2000 (CDMA2000), General Packet Radio Service (GPRS), Global Power supply system for Mobile Communications (GSM), Enhanced Data Rates for GSM Evolution (EDGE), Wibree, ZigBee, Z-Wave, Wireless Universal Serial Bus (WUSB), EnOcean, ONE-NET, Long Term Evolution (LTE), Kumen, and any other communication protocol, whether currently in existence, or not yet developed.

Various embodiments of the present invention are described below. It should be appreciated, however, that the present invention is not limited to any particular manner of implementation, and that the various embodiments discussed explicitly herein are primarily for purposes of illustration. For example, the various concepts discussed herein may be suitably implemented in a variety of environments involving light emitting diode (LED) based light sources, other types of light sources, environments that involve both LED and other types of lights sources in combination, and environments that involve non-lighting-related devices alone or in combination with various types of light sources.

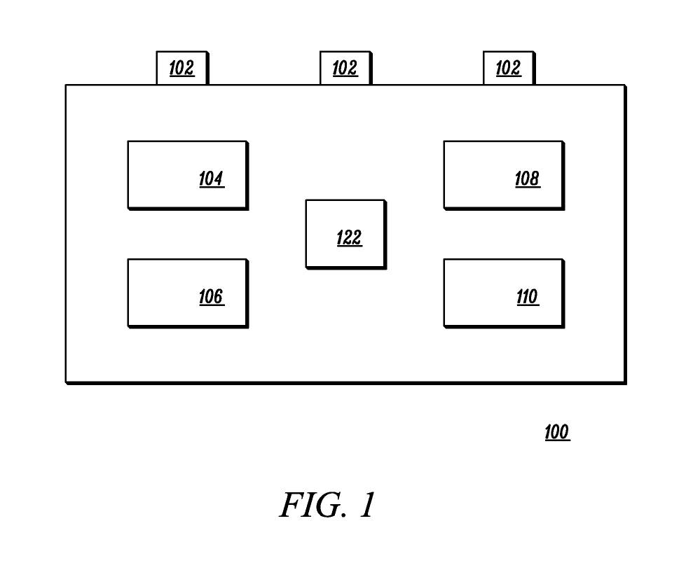

FIG. 1 depicts a schematic diagram of a power supply in accordance with one embodiment of the present invention. In one embodiment, in a basic form, the power supply 100 comprises at least a plurality of selectable outputs 102, an input 104, a logic unit 106, a power unit 108, and an optional converter 110. In addition, the power supply 100 may further comprise an optional user interface 122 for receiving input commands from a user (not shown).

In accordance with one embodiment of the present disclosure, the plurality of selectable outputs 102 may comprise any number of outputs suitable for embodiments of the present invention. Each output 102 of the plurality of outputs may generally be coupled to at least one load, and in many instances, a plurality of loads.

In many embodiments, each output 102 comprises a connector for transmitting signals from the power supply 100 to at least one load (not shown). The connector may comprise any type of connector suitable for embodiments of the present invention. In many embodiments, the connector may comprise any industry-standard connector, including for example, at least one of a XLR connector (e.g., a 3, 4, 5, 6 or 7 pin XLR connector), Registered Jack (RJ) connector, optical fiber connectors (such as an LC, SC or MTP connector), Universal Serial Bus (USB) connectors, screw terminals, D-subminiature connectors, or the like.

In certain embodiments, each output 102 may be required to transmit data and power to a load. In such embodiments, each output 102 must comprise a communications interface for relaying commands and data to and/or from a load, and a power interface for powering the load. In one embodiment, a communication interface may comprise hardware for transmitting and receiving data and commands, for example, hardware adapted for communication using any of the industry-standard communication protocols. In another embodiment, the power interface may comprise hardware for providing requisite power to keep a load in an operating mode, for example, hardware adapted for power or electric signal protocols, such as EIA-485 protocols, or the like.

Each output 102 may further comprise a variable number of slots, or slot size, such that a variable number of loads may be in communication with each output 102. For example, in one embodiment, a first output may be set to comprise 5 slots for loads, and a second output may be set to comprise 3 slots for loads. Using the same embodiment, in another example, the first output may be adjusted to comprise 3 slots for loads, and the second output may be adjusted to comprise 5 slots for loads. It should be appreciated by embodiments of the present invention, designating a particular number of slots per output may be done without physical reconfiguration of the power supply 100, rather the physical connection to the loads is independent of the output which is in communication with any particular load.

In one embodiment of the present invention, the input 104 may comprise a hardware configuration suitable to receive data and or commands from the user interface 122. In many embodiments, the input 104 may comprise any type of connector suitable for embodiments of the present invention. In some embodiments, the connector may comprise any industry-standard connector, including for example, at least one of a XLR connector (e.g., a 3, 4, 5, 6 or 7 pin XLR connector), Registered Jack (RJ) connector, optical fiber connectors (such as an LC, SC or MTP connector), Universal Serial Bus (USB) connectors, screw terminals, D-subminiature connectors, or the like.

The logic unit 106 may comprise any number of components required to perform the necessary functions of the logic unit 106 as described herein. Generally, the logic unit may be configured to process incoming data and/or commands from the input 104, selectively distribute received data or commands to each output 102, may also assign the start address and the number of slots for each output 102.

In order to selectively distribute received data or commands to each output 102, the logic unit 106 may comprise components for identifying an address within received data, selecting the proper output 102 for which the received data is intended, and transmitting the data through the appropriate output 102. Similarly, in order to assign a start address and number of slots for each output 102, the logic unit 106 may comprise components for instructing any number of physically connected loads to receive data or commands for a particular output. In addition, the logic unit 106 may comprise components to selectively identify any individual load, and assign it an address (e.g., a DMX address), to allow for unique control over each load.

The converter 110 may comprise any components suitable to receive data and/or commands formatted in an industry-standard communication protocol and convert the data and/or commands to a protocol compatible with a load. Such protocol conversion allows for the use of the power supply 100 where the incoming data and/or commands are provided using an industry-standard communication protocol, and where the loads require proprietary or manufacturer-specific communication protocols.

In some embodiments, the converter 110 may be capable of bi-directional conversion, such that it may receive data and/or commands formatted in a protocol compatible with the load and convert the data and/or commands to an industry-standard communication protocol. Such embodiments may generally be utilizing a bi-directional industry standard communication protocol, wherein status feedback or other data is expected to be received from the load, to provide a user an indication of any number of operating parameters.

The power unit 108 may comprise any suitable power source for providing power to the loads through each output 102. In many embodiments, the power unit 108 is further required to act as a power source for the power supply itself, whereby the power unit 108 receives power from an external source, directs sufficient power to the components of the power supply 100 for operation, and additionally powers any loads connected thereto. In some embodiments, the external source may be a standard AC wall outlet, battery power, solar power, or combinations thereof. The power unit 108 may then convert the external source of power into a voltage supply sufficient for powering the loads, for example, a direct current power supply.

The user interface 122 may comprise any type of interface for receiving operating parameters from a user. The user interface 122 may be capable of receiving input data and/or commands including, for example, a start address for each output, a number of data slots for each output, and the like. In addition, the user interface 122 may be capable of receiving load-specific commands for controlling the particular operation of a load during use (e.g., color schemes, tilt, positioning, or the like). In many embodiments, the commands may be set using at least one of a Binary Coded Decimal (BCD) switches, Dual In-line Package (DIP) switches, Liquid Crystal Display (LCD) with button keys, and Light-Emitting Diode (LED) with button keys, touch-screen Graphical User Interface (GUI) or the like.

In some embodiments the user interface 122 is positioned on or within a housing of the power supply 100. In many other embodiments, however, the user interface 122 is positioned at a remote location from the power supply, for example, in a control room in a venue. In such embodiments, the user interface 122 may operate with a remote controller (not shown), such that the user interface 122 may transmit the data and/or commands to the power supply 100 using at least one of wired, wireless, and optical interface (e.g., Universal Serial Bus (USB) cable).

In certain embodiments, the user interface 122 may also comprise a memory for storing controls or instructions for operating a plurality of loads. For example, in a theater setting, it may be desirable to have numerous lighting functions occur either simultaneously or on a predetermined schedule. By allowing a programming operation to store instructions in a memory within the user interface or remote controller, a system may be able to operate without additional user input during operation.

In addition, the user interface 122 may optionally act as a diagnostic display for the user. For example, in certain embodiments wherein the loads are capable of provide operation feedback, the display may provide a visual indication of any status, and relay any feedback to the user. In many embodiments, the feedback may comprise any operating parameter, for example, temperature, power level, angle of tilt, interference channels, or the like.

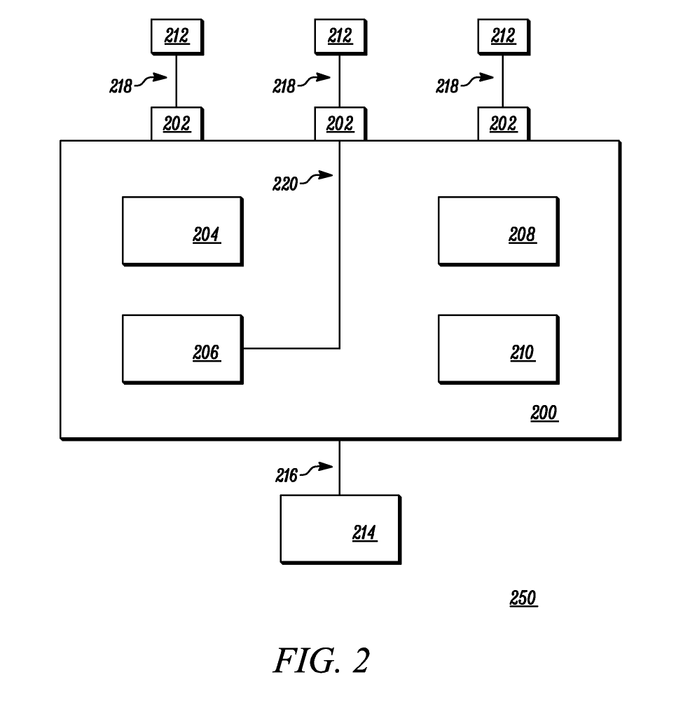

FIG. 2 depicts a schematic diagram of a power supply system in accordance with one embodiment of the present invention. In one embodiment, a power supply system 250 generally comprises a power supply 200, a plurality of loads 212, and optionally a remote controller 214. As discussed above, with respect to FIG. 1, a power supply 200 generally comprises at least a plurality of selectable outputs 202, an input 204, a logic unit 206, a power unit 208, and an optional converter 210.

The remote controller 214 may be configured to remotely transmit control data and/or commands to the input unit 204 for controlling the loads 212. In many embodiments, the remote controller 214 transmits data and/or commands to the input 204 of the power supply 200 using an industry-standard communication protocol. The transmission of data or commands may take place through at least one of wired, wireless, or optical interface.

In certain embodiments, the remote controller 214 may comprise a user interface, such as user interface 122 described above. In such an embodiment, the remote controller 214 may act as a system monitoring and control device, wherein a user may have full access to and complete knowledge of all loads operating within a system from a single remote controller 214.

The loads 212 may comprise any entertainment fixture, including entertainment lighting and effect devices, for example, stationary and moving luminaries, dimmers, stepper motors, fog/smoke generators, and the like. The loads 212 are generally in communication with the power supply 212 through one of the outputs 202, through a connection means 218.

The connection means 218 may comprise any means suitable for embodiments of the present invention, capable of transmitting power and/or data, from the power supply 200 to the load 212. In some embodiments, the connection means 218 comprises at least one of a wired or wireless interface between the power supply 200 and the load 212. In one embodiment, exemplary wired interfaces may comprise the use of a digital, analog or optical cable for transmitting data and power. In another embodiment, exemplary wireless interfaces may comprise any wireless communication protocol for transmitting data, and may comprise any wireless power technology, including induction, electrodynamic induction, microwave and laser technology, or the like. In yet another embodiment, combinations of wired and wireless interfaces may be utilized as a connection means 218.

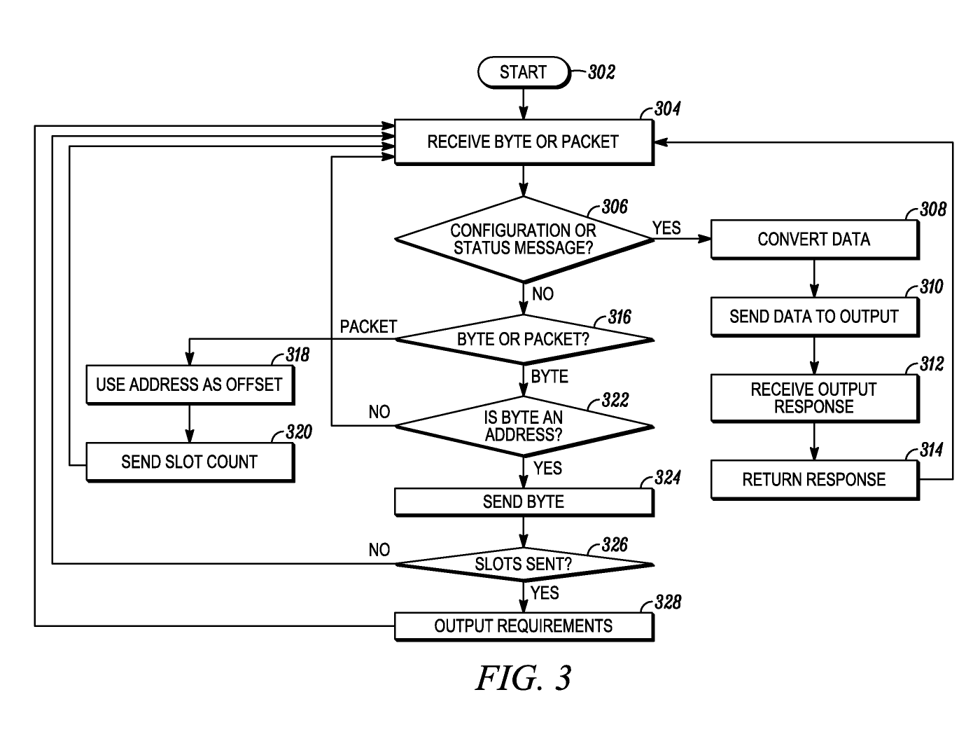

FIG. 3 depicts a flowchart illustrating an exemplary method of processing input data within a power supply in accordance with one embodiment of the present invention. In one exemplary embodiment, the method 300 for operating a plurality of controllable loads starts at step 302. At step 304, a power supply receives data from a remote controller having a user interface therein. At step 306, the logic unit determines whether the data message is a configuration or status message or other type of message.

If the data received is a configuration or status message, at step 308, the data is converted to a format more suitable for instructing the loads. At step 310, the data is sent to the appropriate output, which is identified by certain bit parameters within the data (e.g., identifying an address). Once the data is received by the output, the output may send an output response regarding the data at step 312. The output response may confirm no errors were received, may comprise status information regarding the load or the data, or the like. At step 314, a return response is then transmitted back to the logic unit, and the method 300 returns to step 304.

Returning to step 306, if the data received is not configuration or status message, at step 316, the data is analyzed and determined to be either a byte or a packet. If data received is a packet, at step 318, the address assigned to the port is used as an offset into the data packet. At step 320, the slot count assigned to the port is used to determine how many consecutive slot bytes to send out the port. The method thereafter returns to step 304.

If the data received is a byte, at step 322 the byte's sequence of reception is checked against the assigned address of the port. If the byte sequence does not match the address, the method 300 returns to step 304 to wait additional data. If the byte sequence matches the address assigned, at step 324, the byte is sent to the output port. At step 326, the byte is further evaluated to determine whether the slot count assigned to the port is satisfied. If not, the method 300 returns to step 304 to await addition data. If the slots have been sent, at step 328, the output requirements are evaluated and information is sent to the logic unit for processing. In any event, after step 328, the method 300 returns to step 304.

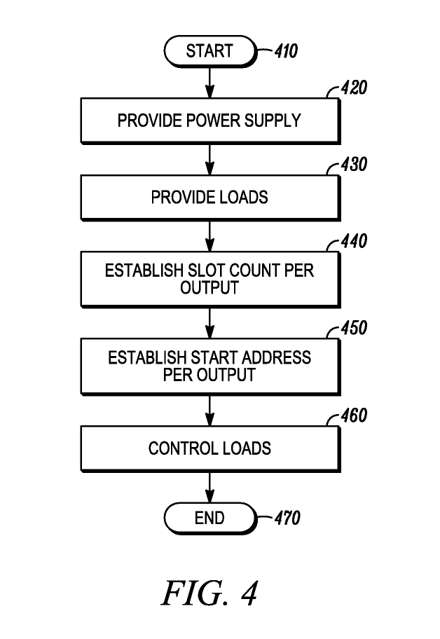

FIG. 4 depicts a flowchart illustrating a method of operating a power supply in accordance with one embodiment of the present invention. The method 400 begins at step 410. At step 420, a power supply is provided. In accordance with embodiment of the present invention, a power supply generally comprises a plurality of outputs, each output configured for an assignable start address and a variable number of slots, an input for receiving data formatted in an industry-standard communication protocol, a logic unit configured to assign the start address and the number of slots for each output, the logic unit further configured to selectively distribute received data to each output, a power unit configured to provide power through each output in terms of voltage type (e.g., AC or DC power, etc.) and current, and a converter configured to receive the data formatted in the industry-standard communication protocol and convert the data to a protocol compatible with a load.

At step 430, a plurality of loads is also provided, and each load is placed in communication with an output of the power supply. The loads may comprise any entertainment or architectural fixture, including entertainment or architectural lighting and effect devices, for example, stationary and moving luminaries, dimmers, stepper motors, fog/smoke generators, and the like.

At step 440, using a user interface, a user may establishing a number of slots for each output of the power supply, and may constructively associate a number of loads therewith. For example, in one embodiment, a first output may be set to comprise 5 slots for loads, and a second output may be set to comprise 3 slots for loads. At step 450, using the user interface, a user may assign a start address for each output of the power supply. The start address may comprise a DMX address, or the like, for identifying where specific data and commands should be directed by the logic unit.

At step 460, the user provides a set of commands, via the user interface, to control at least one or more of the loads. The method 400 ends at step 470. It should be appreciated, however, the method 400 may be repeated as many times as desired, particularly steps 440-460. The steps may be executed substantially simultaneously, to the extent that a user may provide such commands via the user interface at any time during operation.

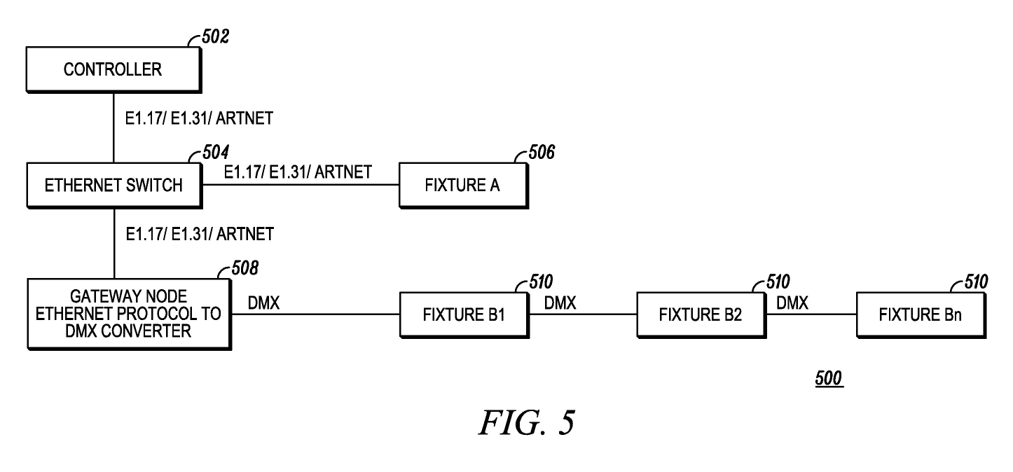

FIG. 5 depicts a schematic diagram of a fixture and control system 500. The fixture and control system 500 may comprise a controller 502, an Ethernet switch 504, a protocol fixture 506, a gateway node 508, and at least one non-industry standard protocol fixture 510. In accordance with the fixture and control system 500, a control signal in an industry-standard communication protocol data format may be transmitted from a controller 502 to an Ethernet switch 504. The signal may then be routed to a protocol fixture 506 and a gateway node 508. The protocol fixture 506 may be configured to receive the control signal in the protocol format. The gateway node 508 may be configured to convert the control signal data formatted in accordance with the protocol to control signal data capable of reception by one or more proprietary or industry standard fixtures 510. The need for dedicated boxes to convert newer protocol data to earlier proprietary or industry standard data formats for distribution to fixtures or end devices requires the user to purchase multiple additional pieces of hardware. The need for dedicated boxes such as gateway nodes results in a significant cost associated with incorporating earlier proprietary or industry standard fixtures in new fixture control systems.

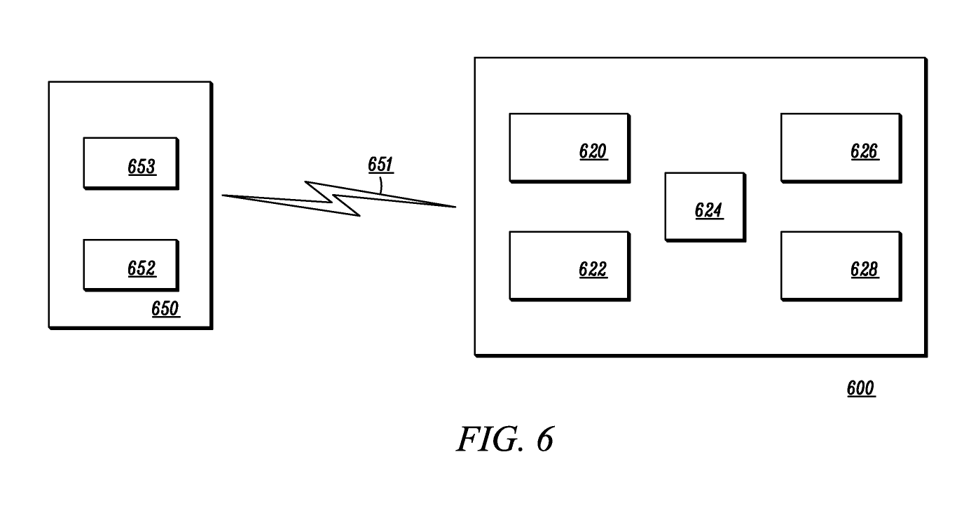

FIG. 6 depicts a system level block diagram of a fixture with integrated gateway 600 in accordance with one embodiment of the present invention. In an embodiment of the present invention, in a basic form, the fixture with integrated gateway 600 may comprise an input 620 for receiving data, an output 622 for transmitting data, a logic unit 624 configured to selectively distribute received data, an optional power unit 626 configured to provide power to the fixture, and an integrated gateway 628 configured to receive industry standard protocol data and convert the received data to a second data format. In addition, the fixture 600 may further comprise an optional user interface 650 for receiving input commands from a user.

In accordance with many embodiments of the present invention, the input 620 may be configured to receive control data for controlling the fixture 600. In many embodiments, the input 620 may comprise circuitry configured to receive control data formatted in any format suitable for embodiments of the present invention. The input 620 may comprise, for example, at least one of wired, wireless, or optical interface.

In one embodiment, exemplary wired interfaces may comprise the use of a digital, analog or optical cable for receiving data and power. In many embodiments, the input may comprise a connector for receiving signals. The connector may comprise any type of connector suitable for embodiments of the present invention. In many embodiments, the connector may comprise any industry-standard connector, including for example, at least one of a XLR connector (e.g., a 3, 4, 5, 6 or 7 pin XLR connector), Registered Jack (RJ) connector, optical fiber connectors (such as an LC, SC or MTP connector), Universal Serial Bus (USB) connectors, screw terminals, D-subminiature connectors, or the like.

In another embodiment, exemplary wireless interfaces may comprise any wireless communication protocol for receiving data, and may comprise any wireless power technology, including induction, electrodynamic induction, microwave and laser technology, or the like. In yet another embodiment, combinations of wired and wireless interfaces may be utilized as a connection means. In many embodiments of the present invention, the input may comprise any circuitry or electronic components capable of receiving data.

In accordance with many embodiments of the present invention, the output 622 may be configured to transmit control data for controlling the fixture 600. In many embodiments, the output 622 may comprise circuitry configured to transmit control data formatted in any format suitable for embodiments of the present invention. The output 622 may comprise, for example, at least one of wired, wireless, or optical interface. In many embodiments, the output may comprise a connector for receiving signals. The connector may comprise any type of connector suitable for embodiments of the present invention. In many embodiments, the connector may comprise any industry-standard connector, including for example, at least one of a XLR connector (e.g., a 3, 4, 5, 6 or 7 pin XLR connector), Registered Jack (RJ) connector, optical fiber connectors (such as an LC, SC or MTP connector), Universal Serial Bus (USB) connectors, screw terminals, D-subminiature connectors, or the like.

In one embodiment, exemplary wired interfaces may comprise the use of a digital, analog or optical cable for receiving data and power. In another embodiment, exemplary wireless interfaces may comprise any wireless communication protocol for receiving data, and may comprise any wireless power technology, including induction, electrodynamic induction, microwave and laser technology, or the like.

In yet another embodiment, combinations of wired and wireless interfaces may be utilized as the output 622 connection means. In accordance with many embodiments of the present invention, the output 622 may comprise, for example, any DMX512-A output connector as defined in the standard E1.11. In accordance with alternative embodiments of the present invention, the input 620 and the output 622 may be combined into a single unit or circuitry. Any number of inputs and outputs are contemplated within the scope of embodiments of the present invention.

In accordance with many embodiments of the present invention, the logic unit 624 may be configured to selectively distribute received data. The logic unit 624 may comprise any number of components required to perform the necessary functions of the logic unit 624 as described herein. Generally, the logic unit may be configured to process incoming data and/or commands from the input 620, process and send control data instructions, and selectively distribute received data or commands to the output 622.

In order to distribute received data or commands to the output 622, the logic unit 624 may comprise components for transmitting the data to the output 622. The logic unit may also comprise circuitry for adjusting fixture-specific attributes. In some embodiments of the present invention, attributes of the fixture 600 may include, for example, intensity, pan, tilt, positioning, color, beam shape, focus, and the like.

The optional power unit 626 may comprise any suitable power source for providing power to the fixture 600. In many embodiments, the power unit 626 may receive power from an external source and direct sufficient power to the components of the fixture 600 for operation. In some embodiments, the external source may be a standard AC wall outlet, battery power, solar power, or combinations thereof. The power unit 626 may then convert the external source of power into a voltage supply sufficient for powering the fixture 600, for example, a direct current power supply.

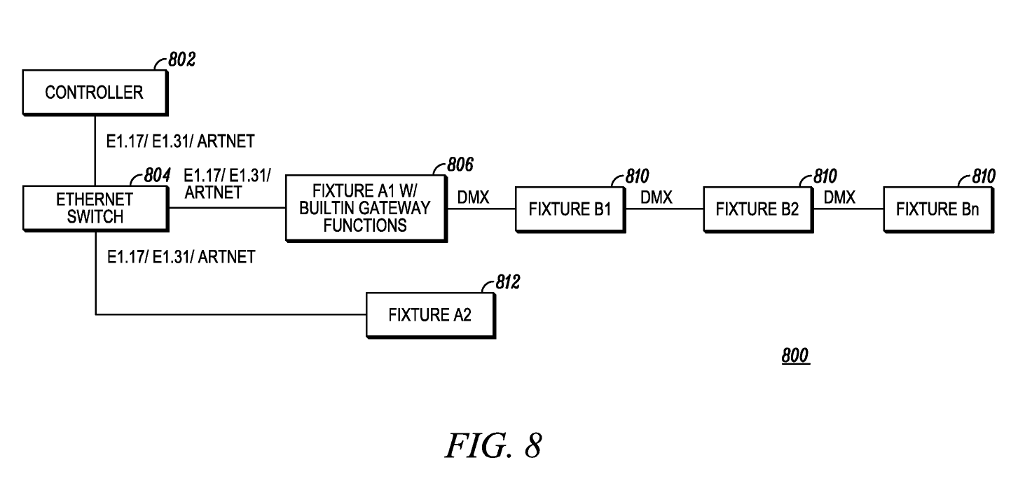

In some embodiments of the present invention, the integrated gateway 628 may be configured to receive industry-standard communication protocol data and convert the received data to a second data format. Such protocol conversion allows for the use of a control system (see e.g., FIG. 8) where the fixtures require data formatted in specific formats, including, for example, specific industry-standard, proprietary, or manufacturer-specific communication protocols. In many embodiments of the present invention, the integrated gateway 628 may comprise an integrated circuitry or a computer-readable code. In accordance with alternative embodiments of the present invention, the integrated gateway 628 may be configured to convert, for example, E1.17, E1.31, or ArtNet data into DMX or DMX512-A.

The user interface 650 may comprise any type of interface for receiving operating parameters from a user. The user interface 650 may be capable of receiving input data and/or commands including, for example, fixture-specific commands for controlling the particular operation of a fixture during use (e.g., intensity, pan, tilt, positioning, color, beam shape, focus, or the like). In many embodiments, the commands may be set using at least one of a Binary Coded Decimal (BCD) switches, Dual In-line Package (DIP) switches, Liquid Crystal Display (LCD) with button keys, and Light-Emitting Diode (LED) with button keys, touch-screen Graphical User Interface (GUI) or the like. In some embodiments the user interface 650 is positioned on or within a housing of the fixture 600. In many other embodiments, however, the user interface 650 is positioned at a remote location from the fixture 600, for example, in a control room in a venue. In such embodiments, the user interface 650 may operate with a remote controller (not shown), such that the user interface 650 may transmit the data and/or commands to the fixture 600 using at least one of wired, wireless, and optical interface 651 (e.g., Universal Serial Bus (USB) cable).

In certain embodiments, the user interface 650 may also comprise a memory 652 for storing controls or instructions for operating a plurality of fixtures. For example, in a theater setting, it may be desirable to have numerous lighting functions occur either simultaneously or on a predetermined schedule. By allowing a programming operation to store instructions in a memory 652 within the user interface 650 or remote controller, a control system may be able to operate without additional user input during operation.

In addition, the user interface 650 may optionally include a diagnostic display 653 for the user. For example, in certain embodiments wherein the fixture 600 is capable of provide operation feedback, the diagnostic display 653 may provide a visual indication of any status, and relay any feedback to the user. In many embodiments, the feedback may comprise any operating parameter, for example, temperature, power level, angle of tilt, interference channels, or the like.

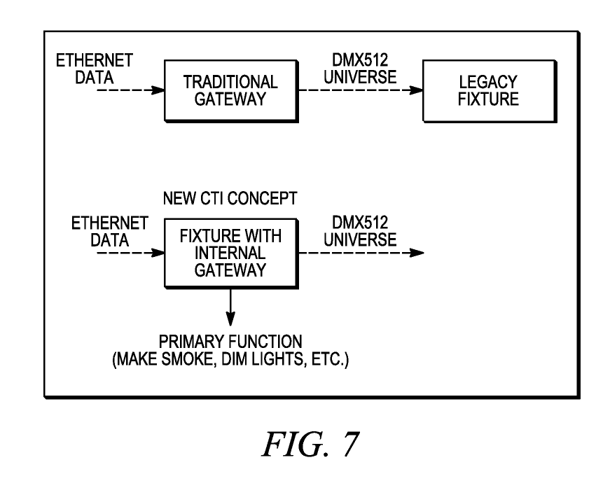

FIG. 7 depicts a side by side schematic comparison of a currently available fixture device with a traditional gateway and a device in accordance with embodiments of the present invention. As shown in the Figure, a device having a traditional gateway generally receives data (e.g., Ethernet Data) and transforms it and transmits it out in a second protocol (e.g., DMX512). As shown in the Figure, an embodiment of the present invention generally receives data (e.g., Ethernet Data), transforms it and transmits it out in a second protocol (e.g., DMX512) to provide control information to another device, for example, a traditional entertainment and/or architectural lighting fixture (e.g., smoke generator, light, dimmer, stepper motor, etc.), and also digests the data, and may perform any controlled function (e.g., intensity, direction, etc.) as instructed.

FIG. 8 depicts a schematic diagram of a fixture system in accordance with one embodiment of the present invention. In one embodiment, a fixture control system 800 generally comprises a controller 802 for transmitting control data to a fixture, wherein the control data may be formatted in an industry-standard communication protocol; an Ethernet switch 804 configured to receive control data formatted in an industry-standard communication protocol and route the control data to at least one fixture with integrated gateway 806; at least one fixture with integrated gateway 806 comprising an output, an input for receiving data formatted in an industry-standard communication protocol, a logic unit configured to selectively distribute received data, an optional power unit configured to provide power to the fixture, and an integrated gateway configured to receive the data formatted in the industry-standard communication protocol and convert the data to a second communication protocol; at least one protocol fixture 810 configured to operate using the second communication protocol; and at least one protocol fixture 812 configured to operate using the industry-standard communication protocol. The second communication protocol may include, but is not limited to, a proprietary protocol or an industry-standard communication protocol different than that used by controller 802.

In many embodiments of the present invention the controller 802 may be configured to transmit control data to the Ethernet switch 804 for controlling the fixtures 806, 810, and/or 812. In many embodiments, the controller 802 transmits data and/or commands to the Ethernet switch 804 using an industry-standard communication protocol. The transmission of data or commands may take place through at least one of wired, wireless, or optical interface, and may be done using any available transmission means suitable for embodiments of the present invention.

In certain embodiments, the controller 802 may comprise a user interface, such as the user interface described above. In such an embodiment, the controller 802 may act as a fixture system monitoring and control device, wherein a user may have full access to and complete knowledge of all fixtures operating within a fixture system from a single controller 802.

The connection means between the Controller 802 and the Ethernet switch 804 may comprise any means suitable for embodiments of the present invention, capable of transmitting power and/or data, from the controller 802 to the Ethernet switch 804. In some embodiments, the connection means comprises at least one of a wired or wireless interface between the controller 802 and the Ethernet switch 804. In one embodiment, exemplary wired interfaces may comprise the use of a digital, analog or optical cable for transmitting data and/or power. In another embodiment, exemplary wireless interfaces may comprise any wireless communication protocol for transmitting data, and may comprise any wireless power technology, including induction, electrodynamic induction, microwave and laser technology, or the like. In yet another embodiment, combinations of wired and wireless interfaces may be utilized as a connection means.

In accordance with many embodiments of the present invention, the Ethernet switch 804 may be configured to receive control data formatted in an industry-standard communication protocol and route the control data to at one or more of the least one fixture with integrated gateway 806, at least one protocol fixture 810 configured to operate using a second communication protocol, and at least one new protocol fixture 812 configured to operate using the industry-standard communication protocol. The second communication protocol may include, but is not limited to, a proprietary protocol or an industry-standard communication protocol different than the communication protocol used by controller 802. The Ethernet switch 804 may operate to sufficiently route control data in accordance with embodiments of the present invention. In some embodiments, the Ethernet switch 804 may comprise, for example, a network switch or switching hub that connects network segments. Such an exemplary embodiment allows for a dedicated bandwidth on point-to-point connections with every device in the system 800 and operates to minimize data collisions.

In accordance with many embodiments of the present invention, the fixture control system 800 may include the at least one fixture with integrated gateway 806 described above in FIG. 8. In alternative embodiments of the present invention, the fixture control system 800 may comprise at least one fixture with integrated gateway 806 converting between a first communication protocol and a second communication protocol, and at least one protocol fixture 810 configured to operate using the second communication protocol. The second communication protocol may include, but is not limited to, a proprietary protocol or an industry-standard protocol different than the first communication protocol.

In yet further alternative embodiments of the present invention, the fixture control system 800 may comprise at least one fixture with integrated gateway 806 configured to convert between a first communication protocol and a second communication protocol, at least one protocol fixture 810 configured to operate using the second communication protocol, and at least one protocol fixture 812 configured to operate using the first communication protocol. In accordance with many embodiments of the present invention, the protocol fixture 812 may be configured to receive data using the first communication protocol, such as, for example, E1.17 or E1.31 or E1.33 or ArtNet and therefore may not require the use of gateway functionality for conversion of protocol data. It should be noted however, the first and second communication protocols should not be limited to any particular protocol per se.

In operation, the controller 802 may transmit control data in one industry-standard communication protocol, which may be received by the Ethernet switch 804. The Ethernet switch may route the control data to one or more fixtures. Generally, a fixture integrated gateway 806 and/or a communication protocol fixture 812 will receive the control data. The control data may be converted by the fixture with integrated gateway 806 into a second data format for reception by one or more old protocol fixtures 810 configured to operate using the second communication format, and the control data may also be transmitted to and received by the one or more protocol fixtures 812. Accordingly, the fixtures 806, 810, 812 may operate in accordance with instructions included in the control data.

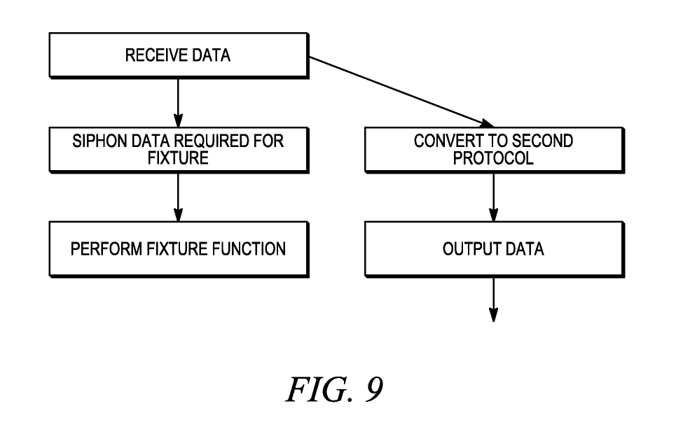

FIG. 9 depicts an exemplary flowchart of data processing within a device in accordance with one embodiment of the present invention. As shown in the Figure, when a device receives data, the data may be processed in one of two manners, depending on the instructions contained therein. In many embodiments, the data received by the device contains instructions for the device itself and for another device/fixture. In one manner of processing, data is siphoned and instructions for the device (e.g., fixture) are read by the device. Accordingly, the device performs the function provided therein (e.g., execute a certain pattern, turn on/off, pan left/right, etc.).

Where the data received provides instructions for another fixture, the device may convert the data received into a second protocol, and subsequently output the data to the other fixture. The detailed steps of converting protocols and transmitting data are described in other embodiments, disclosed herein.

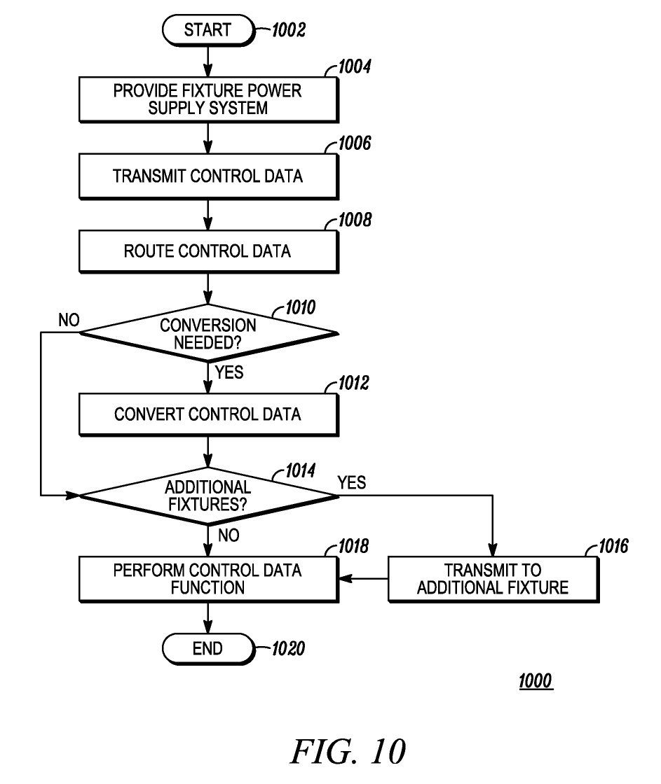

FIG. 10 depicts a flowchart illustrating an exemplary method of processing control data within a fixture control system in accordance with one embodiment of the present invention. In one exemplary embodiment, the method 1000 for operating a plurality of controllable fixtures starts at step 1002. At step 1004, a control system in accordance with any embodiment of the present invention is provided. A control system may comprise, for example, a controller for transmitting control data to a fixture, the control data formatted in an industry-standard communication protocol; an Ethernet switch configured to receive control data formatted in an industry-standard communication protocol and route the control data to at least one fixture with integrated gateway; at least one fixture with integrated gateway comprising an output, an input for receiving data formatted in an industry-standard communication protocol, a logic unit configured to selectively distribute received data, an optional power unit configured to provide power to the fixture, and an integrated gateway configured to receive the data formatted in the industry-standard communication protocol and convert the data to a second communication protocol; at least one protocol fixture configured to operate using the second communication protocol; and at least one protocol fixture configured to operate using the industry-standard communication protocol. The second communication protocol may include, but is not limited to, a proprietary protocol or another industry-standard communication protocol. Any number of controllers, Ethernet switches, and fixtures, and any combination thereof are contemplated within the scope of embodiments of the present invention.

At step 1006, a controller transmits control data in a first data format. Generally the control data may comprise data for controlling fixture-specific attributes for fixtures associated with the control system. For example, fixture-specific attributes may include, for example, intensity, pan, tilt, positioning, color, beam shape, focus, and the like. Any function, attribute, or setting of any fixture or any combination of functions, attributes, or settings is contemplated within the scope of embodiments of the present invention. Generally the control data may comprise either industry-standard or proprietary data formats. Industry standard data may comprise, for example, data formatted in accordance with the E1.17, E1.31, E1.33, ArtNet, or DMX protocols. Although specific data formats are disclosed herein, any data format is contemplated within the embodiments of the present invention.

At step 1008, the control data is received by an Ethernet switch and routed to the appropriate fixtures in accordance to the control data instructions or port connections. In accordance with alternative embodiments of the present invention, the Ethernet switch may route data based upon which physical port on the switch fixtures are connected to. An example of such routing may be found in U.S. patent application Ser. No. 12/618,712, published on Apr. 15, 2010 as U.S. Patent Application Publication No. 2010/0094478, the content of which has been incorporated by reference in its entirety.

At step 1010, the control data is received by a fixture with integrated gateway in accordance with any embodiment of the present invention and a determination is made by the logic circuit whether a data conversion is necessary. The integrated gateway may comprise, for example, a set of software code or machine instructions installed in the fixture. In alternative embodiments of the present invention, the integrated gateway may comprise a circuitry installed in the fixture.

If a data conversion is not needed, the method proceeds to step 1014 where a determination of whether the control data comprises instructions to transmit to additional fixtures. However, if a data conversion is necessary, the data is converted to a second data format at step 1012. In one embodiment of the present invention, the first and second data formats may comprise any industry-standard or non-industry standard data formats. In accordance with many embodiments of the present invention, the control data may be converted from E1.17, E1.31, E1.33 or, ArtNet format to DMX format. After the data conversion is complete, the method proceeds to step 1014, as described above.

If the control data comprises constructions to transmit to additional fixtures at step 1014, data is then transmitted to the fixtures in accordance with control data instructions at step 1016 and all system fixtures perform functions in accordance with control data instructions. Generally, the control data may comprise an indication of the specific fixtures to which the control data must be transmitted. In one embodiment of the present invention, the control data may comprise an indication to transmit instructions to any number of fixtures capable of support by any control system in accordance with embodiments of the present invention. In another embodiment of the present invention, the control data my comprise instructions to transmit to all fixtures within the control system. In alternative embodiments of the present invention, the control data may comprise instructions to transmit to specific fixtures within the control system.

If transmission to additional fixtures is not needed, the fixture with integrated gateway performs functions in accordance with the control data instructions at step 1018. In accordance with one embodiment of the present invention, control data instructions may comprise, for example, parameters for adjustment of fixture intensity, pan, tilt, positioning, color, beam shape, focus, and the like. The method ends at step 1020.

It should be emphasized that the above-described embodiments of the present invention are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this invention.

What is claimed is:

1. A fixture with integrated gateway, the fixture comprising:
an output;
an input for receiving data formatted in an industry-standard communication protocol;
a logic unit configured to selectively distribute received data; and
an integrated gateway configured to receive the data formatted in the industry-standard communication protocol and convert the data to a second data format.

2. The fixture of claim 1, further comprising:
a user interface, in communication with the integrated gateway, for receiving input commands from a user.

3. The fixture of claim 2, wherein the user interface further comprises a memory for storing a control for operation of the fixture.

4. The fixture of claim 2, wherein the user interface further comprises a diagnostic display for the user.

5. The fixture of claim 1, wherein the output is configured to transmit control data for controlling the fixture.

6. The fixture of claim 1, wherein the output comprises a combination of wired and wireless interfaces.

7. The fixture of claim 1, wherein the logic unit is further configured to process incoming data and/or commands from the input, to process and to send control data instructions, and to selectively distribute received data or commands to the output.

8. The fixture of claim 1, wherein the logic unit further comprises circuitry for adjusting fixture-specific attributes.

9. A fixture control system comprising:
a controller for transmitting control data to fixtures, the control data formatted in an industry-standard communication protocol;
an Ethernet switch configured to receive control data formatted in an industry-standard communication protocol and route the control data to at least one fixture with integrated gateway, the at least one fixture with integrated gateway comprising:
an output;
an input for receiving data formatted in an industry-standard communication protocol;
a logic unit configured to selectively distribute received data; and
an integrated gateway configured to receive the data formatted in the industry-standard communication protocol and convert the data to a second data format.

10. The fixture control system of claim 9, wherein the output comprises combinations of wired and wireless interfaces.

11. The fixture control system of claim 9, wherein the fixture further comprises a user interface, in communication with the integrated gateway, for receiving input commands from a user.

12. The fixture control system of claim 11, wherein the user interface further comprises a memory for storing a control for operation of the fixture.

13. The fixture control system of claim 11, wherein the user interface further comprises a diagnostic display for the user.

14. The fixture control system of claim 9, wherein the output is configured to transmit control data for controlling the fixture.

15. The fixture control system of claim 9, wherein the logic unit is further configured to process incoming data and/or commands from the input, to process and to send control data instructions, and to selectively distribute received data or commands to the output.

16. The fixture control system of claim 9, wherein the logic unit further comprises circuitry for adjusting feature-specific attributes.

17. A method for operating a plurality of controllable fixtures, wherein one of the plurality of controllable fixtures comprises:
a controller for transmitting control data to at least one fixture, the control data formatted in an industry-standard communication protocol; and
an Ethernet switch configured to receive control data formatted in an industry-standard communication protocol and route the control data to at least one fixture with integrated gateway,
and further wherein the at least one fixture with integrated gateway comprises:
an output;
an input for receiving data formatted in an industry-standard communication protocol;
a logic unit configured to selectively distribute received data; and
an integrated gateway configured to receive the data formatted in the industry-standard communication protocol and convert the data to a second data format, the method for operating a plurality of controllable fixtures comprising:
transmitting control data formatted in an industry-standard communication protocol from the controller to the Ethernet switch;
routing the control data to the at least one fixture with integrated gateway;
converting the control data to a second data format; and
transmitting the converted control data to an additional fixture capable of receiving the converted control data.

18. The method of claim 17, wherein the fixture further comprises a user interface, in communication with the integrated gateway, for receiving input commands from a user.

19. The method of claim 17, wherein the user interface further comprises a diagnostic display for the user.

20. The method of claim 17, wherein the logic unit is further configured to process incoming data and/or commands from the input, to process and to send control data instructions, and to selectively distribute received data or commands to the output.
